(19) United States
(12) Patent Application Publication
(10) Pub. No.: US 2025/0272757 A1
(43) Pub. Date: Aug. 28, 2025

(54) DETERMINING A SUBROGATION VALUE OF A PLURALITY OF INSURANCE CLAIMS

(71) Applicant: CCC INTELLIGENT SOLUTIONS, INC., Chicago, IL (US)

(72) Inventor: Marc FREDMAN, Chicago, IL (US)

(21) Appl. No.: 18/590,135

(22) Filed: Feb. 28, 2024

(51) Int. Cl. G06Q 40/08; G06Q 30/08; G06Q 40/04

(52) U.S. Cl. CPC G06Q 40/08; G06Q 30/08; G06Q 40/04

(57) ABSTRACT

The system and method may normalize the data on the insurance claim using a normalization engine to create normalized data. A new claim may be analyzed to determine the features identified by a machine learning algorithm in an analysis engine that has analyzed past insurance claims. Weights determined by a machine learning algorithm in the analysis engine may be applied to the features of the new claim. A subrogation estimate for the new claim may be determined in a value engine. The offer engine may be used to determine an offer for the claim based on the subrogation value.

### BACKGROUND

Subrogation in insurance involves reviewing a claim and determining if other parties involved in the claim should be responsible for payment of some or all of a claim. Traditionally, determining the possibility of subrogation is a manual process performed by humans which takes a significant amount of time and often misses subrogation opportunities. The potential to find subrogation amounts has created opportunities for third parties to review claims and find subrogation value in exchange for a fee or a percentage of the subrogation moneys recovered. This process typically misses subrogation opportunities and takes a significant amount of time for the money to be recovered by the insurance company.

### SUMMARY OF THE INVENTION

A system and method of determining an expected subrogation recovery value of one or more insurance claims is disclosed. The system and method may normalize the data on the insurance claim using a normalization engine to create normalized data. A new claim may be analyzed to determine the features identified by a machine learning algorithm in an analysis engine that has analyzed past insurance claims. Weights determined by a machine learning algorithm in the analysis engine may be applied to the features of the new claim. A subrogation estimate for the new claim may be determined in a value engine. The offer engine may be used to determine an offer for the claim based on the expected subrogation recovery value.

### BRIEF DESCRIPTION OF THE DRAWINGS

FIG. 1 may be an illustration of computer based learning system;

FIG. 2 may be an illustration of a method in accordance with the claims;

FIG. 3 may be an illustration of a convolutional neural network; and

FIG. 4 may be an illustration of a computer that may be physically transformed to execute the method.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein. All dimensions specified in this disclosure may be by way of example only and are not intended to be limiting. Further, the proportions shown in these Figures may not be necessarily to scale. As will be understood, the actual dimensions and proportions of any system, any device or part of a system or device disclosed in this disclosure may be determined by its intended use.

### SPECIFICATION

Subrogation in insurance involves reviewing a claim and determining if other parties involved in the claim should be responsible for payment of some or all of a claim. Traditionally, determining the possibility of subrogation is a manual process performed by humans which takes a significant amount of time and often misses subrogation opportunities. The potential to find subrogation amounts has created opportunities for third parties to review claims and find subrogation value in exchange for a fee or percentage of the subrogation moneys recovered. This process typically misses subrogation opportunities and takes a significant amount of time for the money to be recovered by the insurance company.

A system and method of determining an expected subrogation recovery value of one or more insurance claims is disclosed. The system and method may normalize the data on the insurance claim using a normalization engine to create normalized data. A new claim may be analyzed to determine the features identified by a machine learning algorithm in an analysis engine that has analyzed past insurance claims. Weights determined by a machine learning algorithm in the analysis engine may be applied to the features of the new claim. A subrogation estimate for the new claim may be determined in a value engine. The offer engine may be used to determine an offer for the claim based on the expected subrogation recovery value.

Methods and devices that may implement the embodiments of the various features of the invention will now be described with reference to the drawings. The drawings and the associated descriptions may be provided to illustrate embodiments of the invention and not to limit the scope of the invention. Reference in the specification to “one embodiment” or “an embodiment” may be intended to indicate that a particular feature, structure, or characteristic described in connection with the embodiment may be included in at least an embodiment of the invention. The appearances of the phrase “in one embodiment” or “an embodiment” in various places in the specification may not necessarily be referring to the same embodiment.

Throughout the drawings, reference numbers may be re-used to indicate correspondence between referenced elements. As used in this disclosure, except where the context requires otherwise, the term “comprise” and variations of the term, such as “comprising”, “comprises” and “comprised” may not be intended to exclude other additives, components, integers or steps.

In the following description, specific details may be given to provide a thorough understanding of the embodiments. However, it may be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures may illustrate the architecture, functionality, and operation of possible implementations of systems, methods and computer programs according to various embodiments disclosed. In this regard, each block in the flowchart or block diagrams may represent a module, segment, or portion of code, that may include one or more executable instructions for implementing the specified logical function(s). It should also be noted that, in some alternative implementations, the functions noted in the blocks may occur out of the order noted in the figures.

Although a flowchart may describe the operations as a sequential process, many of the operations may be performed in parallel or concurrently. In addition, the order of the operations may be rearranged. A process may be terminated when its operations are completed. A process may correspond to a method, a function, a procedure, a subroutine, a subprogram, etc. When a process corresponds to a function, its termination may correspond to a return of the function to the calling function or the main function. Additionally, each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” may include, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

A system and method of determining an expected subrogation recovery value of a plurality of insurance claims is disclosed. For simplicity of understanding, the application will discuss the system and method primarily in terms of automobile claims but the system and method are applicable to many type of insurance claims such as home claims, personal property claims, vehicle claims, casualty claims, liability claims, health claims, pet claims, disability claims, business interruption claims, professional liability claims, flood claims, commercial claims, umbrella claims and travel insurance claims. Of course, other types of claims are possible and are contemplated.

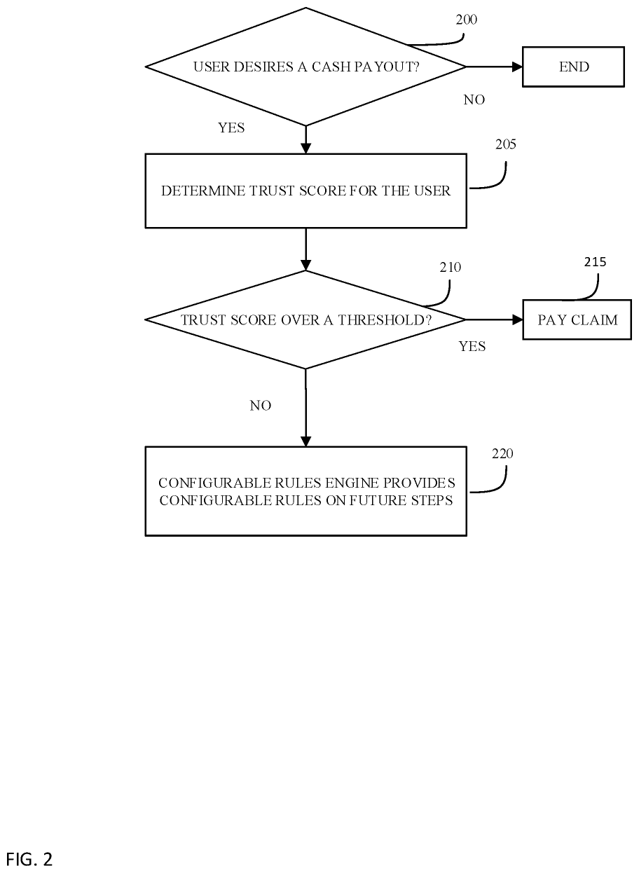

Referring to FIG. 2, at block 200 the data on the insurance claim may be normalized using a normalization engine to create normalized data. The insurance claim may have notes and some form fields filled in. A normalization engine may be used to take the notes and other information in the insurance claim and put it into a standard format such that the data may be easily and accurately analyzed.

More specifically, the system and method may use machine learning to analyze all the data in a claim file and determine the proper classification of the data. For example, notes about the weather during the claim incident may be added to a weather field while notes about any witnesses may be added to a witness field. However, the location of the weather data may be in a variety of places in the file. In some instances, the weather may be noted in a police report. All police reports are not the same and the weather may be noted in different places on different forms. In other instances, the weather may be obtained from the claimant. In other instances, photographs of the scene may be analyzed to obtain weather information. In additional instances, additional outside resources such as online weather data may be consulted to obtain weather information. By normalizing the data, the data may be analyzed in a more consistent fashion.

### CNN

The features from text, audio, photographs, scans or images may be extracted in a variety of ways. In one embodiment, the features are extracted using computer vision techniques and a variety of computer vision techniques are possible. In other embodiments, features are extracted using pre-trained machine learning models. For example, the pre-trained machine learning model may be a convolutional neural network (CNN). The CNN may be trained on millions of images of people and may have learned to understand the thoughts from the photos. This CNN may be novel because it has been created and trained on known images only. Logically, other types of learning algorithms in the estimator may be used. For example, the learning algorithm may be a fully connected neural network (FCN) in one embodiment.

Turning the images into data may entail taking measurements of different points on the object. The points may be compared to baseline of measurements for the object and the changes may be noted. The system may then analyze the changes to determine the extent of movement.

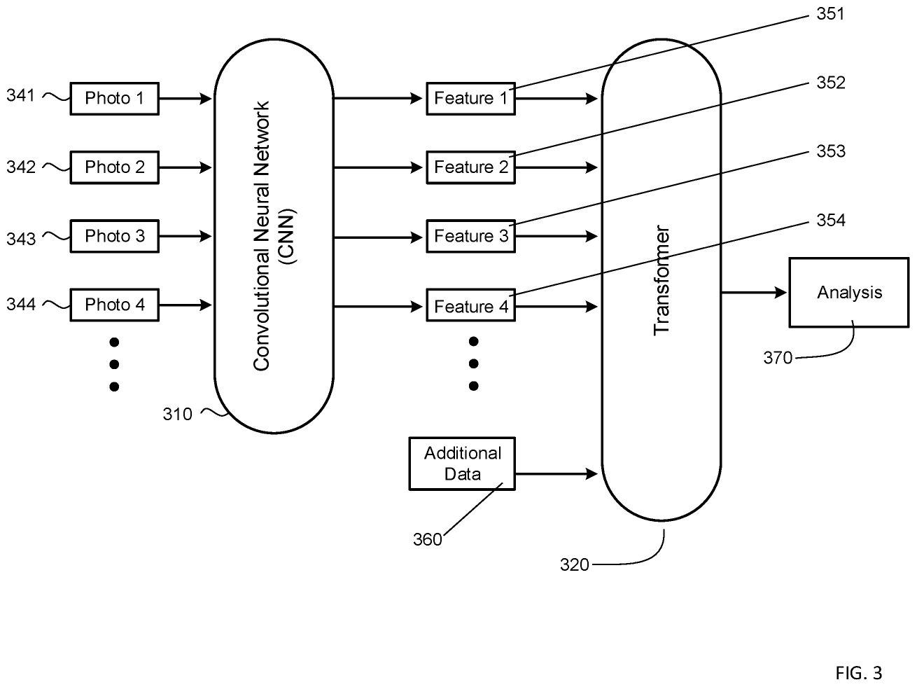

More specifically, referring to FIG. 3, the learning algorithm may include a convolutional neural network 310 (CNN) and a transformer 320. In one embodiment, the CNN 310 may determine one or more features 351-354 in each photo or scan of a document 341-344. In one example, the CNN may determine the features 351-354 which may be a set of numbers but the amount of features 351-354 may be varied up or down depending on many factors.

The CNN may be trained on millions of images of people or documents and may have learned to understand the features from the photos. This CNN may be novel because it has been created and trained on known images. Logically, other types of learning algorithms in the may be used. For example, the learning algorithm may be a fully connected neural network (FCN) in one embodiment. The analysis of the features may indicate the changes to the physical appearance of the objects in the photo or scans.

In training, the transformer 320 may take the features 351-354 of multiple images or scans 341-344 of the same person or thing (the outputs of the CNN) as well as additional data such as the stated damage of the vehicle in the photo 360 to create a model. Once the model is trained, the transformer may generate an analysis which may be a prediction 370. In some embodiments, the analysis which may be estimation of the subrogation value 370 may be in real time. The transformer 320 used in this invention may be trained on a dataset specifically created for predicting subrogation amounts 370.

The trained model which may be in the transformer 320 may take the features of multiple images 341-344 of the same object as well as outside information in order to predict the thought process of the object. The learning algorithm also may analyze other relevant information about the object.

Similar approaches may be used depending on the type of insurance that is involved. If the insurance is workman's compensation, the data on the accident may come from a variety of sources such as from a doctor, a supervisor, images from the worksite, etc. The injury data may be selected and placed in an injury field to aid in a consistent analysis of the injury. Of course, different data may be involved in each insurance type and the system and method may have the flexibility to handle each insurance type in a consistent fashion.

### Machine Learning

At a high level, a machine learning algorithm may analyze past claims to determine features and to determine a weight for each feature as related to subrogation. Machine learning may be used to recognize patterns. The machine learning model may be trained on a model on an existing dataset and the model may be used to predict whether the facts of a claim match known patterns. The machine learning model may be used to predict future actions based on past pattern recognition. The machine learning model may also be used to determine pattern deviation. Logically, pattern deviation may be used to determine future actions.

A framework for a machine learning algorithm like a large language model may involve a combination of one or more components, sometimes three components: (1) representation, (2) evaluation, and (3) optimization components. Representation components refer to computing units that perform steps to represent knowledge in different ways, including but not limited to as one or more decision trees, sets of rules, instances, graphical models, neural networks, support vector machines, model ensembles, and/or others. Evaluation components refer to computing units that perform steps to represent the way hypotheses (e.g., candidate programs) are evaluated, including but not limited to as accuracy, prediction and recall, squared error, likelihood, posterior probability, cost, margin, entropy k-L divergence, and/or others. Optimization components refer to computing units that perform steps that generate candidate programs in different ways, including but not limited to combinatorial optimization, convex optimization, constrained optimization, and/or others. In some embodiments, other components and/or sub-components of the aforementioned components may be present in the system to further enhance and supplement the aforementioned machine learning functionality.

Machine learning algorithms sometimes rely on unique computing system structures. Machine learning algorithms may leverage neural networks, which are systems that approximate biological neural networks (e.g., the human brain). Such structures, while significantly more complex than conventional computer systems, are beneficial in implementing machine learning. For example, an artificial neural network may be comprised of a large set of nodes which, like neurons in the brain, may be dynamically configured to effectuate learning and decision-making.

Machine learning tasks are sometimes broadly categorized as either unsupervised learning or supervised learning. In unsupervised learning, a machine learning algorithm is left to generate any output (e.g., to label as desired) without feedback. The machine learning algorithm may teach itself (e.g., observe past output), but otherwise operates without (or mostly without) feedback from, for example, a human administrator. Meanwhile, in supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithm may make a guess in a face detection algorithm, ask an administrator to identify the photo in the picture, and compare the guess and the administrator's response. In semi-supervised learning, a machine learning algorithm is provided a set of example labels along with unlabeled data. For example, the machine learning algorithm may be provided a data set of 100 photos with labeled human faces and 10,000 random, unlabeled photos. In reinforcement learning, a machine learning algorithm is rewarded for correct labels, allowing it to iteratively observe conditions until rewards are consistently earned. For example, for every face correctly identified, the machine learning algorithm may be given a point and/or a score (e.g., “75% correct”). An embodiment involving supervised machine learning is described herein.

As elaborated herein, in practice, machine learning systems and their underlying components are tuned by data scientists to perform numerous steps to perfect machine learning systems. The process is sometimes iterative and may entail looping through a series of steps: (1) understanding the domain, prior knowledge, and goals; (2) data integration, selection, cleaning, and pre-processing; (3) learning models; (4) interpreting results; and/or (5) consolidating and deploying discovered knowledge. This may further include conferring with domain experts to refine the goals and make the goals more clear, given the nearly infinite number of variables that can possible be optimized in the machine learning system. Meanwhile, one or more of data integration, selection, cleaning, and/or pre-processing steps can sometimes be the most time consuming because the old adage, “garbage in, garbage out,” also reigns true in machine learning systems.

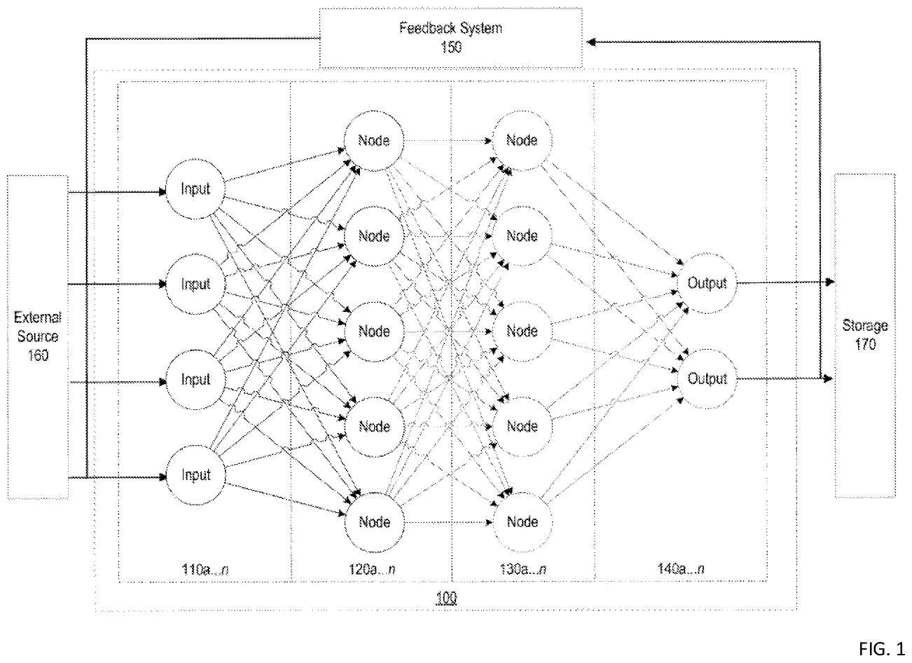

By way of example, FIG. 1 illustrates a simplified example of an artificial neural network 100 on which a machine learning algorithm may be executed. FIG. 1 is merely an example of nonlinear processing using an artificial neural network; other forms of nonlinear processing may be used to implement a machine learning algorithm in accordance with features described herein.

In FIG. 1, each of input nodes 110 a-n is connected to a first set of processing nodes 120 a-n. Each of the first set of processing nodes 120 a-n is connected to each of a second set of processing nodes 130 a-n. Each of the second set of processing nodes 130 a-n is connected to each of output nodes 140 a-n. Though only two sets of processing nodes are shown, any number of processing nodes may be implemented. Similarly, though only four input nodes, five processing nodes, and two output nodes per set are shown in FIG. 1, any number of nodes may be implemented per set. Data flows in FIG. 1 are depicted from left to right: data may be input into an input node, may flow through one or more processing nodes, and may be output by an output node. Input into the input nodes 110 a-n may originate from an external source 160. Output may be sent to a feedback system 150 and/or to storage 170. The feedback system 150 may send output to the input nodes 110 a-n for successive processing iterations with the same or different input data.

In one illustrative method using feedback system 150, the system may use machine learning to determine an output. The output may include anomaly scores, heat scores/values, confidence values, and/or classification output. The system may use any machine learning model including xgboosted decision trees, auto-encoders, perceptron, decision trees, support vector machines, regression, and/or a neural network. The neural network may be any type of neural network including a feed forward network, radial basis network, recurrent neural network, long/short term memory, gated recurrent unit, auto encoder, variational autoencoder, convolutional network, residual network, Kohonen network, and/or other type. In one example, the output data in the machine learning system may be represented as multi-dimensional arrays, an extension of two-dimensional tables (such as matrices) to data with higher dimensionality.

The neural network may include an input layer, a number of intermediate layers, and an output layer. Each layer may have its own weights. The input layer may be configured to receive as input one or more feature vectors described herein. The intermediate layers may be convolutional layers, pooling layers, dense (fully connected) layers, and/or other types. The input layer may pass inputs to the intermediate layers. In one example, each intermediate layer may process the output from the previous layer and then pass output to the next intermediate layer. The output layer may be configured to output a classification or a real value. In one example, the layers in the neural network may use an activation function such as a sigmoid function, a Tan h function, a ReLu function, and/or other functions. Moreover, the neural network may include a loss function. A loss function may, in some examples, measure a number of missed positives; alternatively, it may also measure a number of false positives. The loss function may be used to determine error when comparing an output value and a target value. For example, when training the neural network the output of the output layer may be used as a prediction and may be compared with a target value of a training instance to determine an error. The error may be used to update weights in each layer of the neural network.

In one example, the neural network may include a technique for updating the weights in one or more of the layers based on the error. The neural network may use gradient descent to update weights. Alternatively, the neural network may use an optimizer to update weights in each layer. For example, the optimizer may use various techniques, or combination of techniques, to update weights in each layer. When appropriate, the neural network may include a mechanism to prevent overfitting-regularization (such as L1 or L2), dropout, and/or other techniques. The neural network may also increase the amount of training data used to prevent overfitting.

Once data for machine learning has been created, an optimization process may be used to transform the machine learning model. The optimization process may include (1) training the data to predict an outcome, (2) defining a loss function that serves as an accurate measure to evaluate the machine learning model's performance, (3) minimizing the loss function, such as through a gradient descent algorithm or other algorithms, and/or (4) optimizing a sampling method, such as using a stochastic gradient descent (SGD) method where instead of feeding an entire dataset to the machine learning algorithm for the computation of each step, a subset of data is sampled sequentially. In one example, optimization comprises minimizing the number of false positives to maximize a user's experience. Alternatively, an optimization function may minimize the number of missed positives to optimize minimization of losses from exploits.

In one example, FIG. 1 depicts nodes that may perform various types of processing, such as discrete computations, computer programs, and/or mathematical functions implemented by a computing device. For example, the input nodes 110 a-n may comprise logical inputs of different data sources, such as one or more data servers. The processing nodes 120 a-n may comprise parallel processes executing on multiple servers in a data center. And, the output nodes 140 a-n may be the logical outputs that ultimately are stored in results data stores, such as the same or different data servers as for the input nodes 110 a-n. Notably, the nodes need not be distinct. For example, two nodes in any two sets may perform the exact same processing. The same node may be repeated for the same or different sets.

Each of the nodes may be connected to one or more other nodes. The connections may connect the output of a node to the input of another node. A connection may be correlated with a weighting value. For example, one connection may be weighted as more important or significant than another, thereby influencing the degree of further processing as input traverses across the artificial neural network. Such connections may be modified such that the artificial neural network 100 may learn and/or be dynamically reconfigured. Though nodes are depicted as having connections only to successive nodes in FIG. 1, connections may be formed between any nodes. For example, one processing node may be configured to send output to a previous processing node.

Input received in the input nodes 110 a-n may be processed through processing nodes, such as the first set of processing nodes 120 a-n and the second set of processing nodes 130 a-n. The processing may result in output in output nodes 140 a-n. As depicted by the connections from the first set of processing nodes 120 a-n and the second set of processing nodes 130 a-n, processing may comprise multiple steps or sequences. For example, the first set of processing nodes 120 a-n may be a rough data filter, whereas the second set of processing nodes 130 a-n may be a more detailed data filter.

The artificial neural network 100 may be configured to effectuate decision-making. As a simplified example for the purposes of explanation, the artificial neural network 100 may be configured to detect faces in photographs. The input nodes 110 a-n may be provided with a digital copy of a photograph. The first set of processing nodes 120 a-n may be each configured to perform specific steps to remove non-facial content, such as large contiguous sections of the color red. The second set of processing nodes 130 a-n may be each configured to look for rough approximations of faces, such as facial shapes and skin tones. Multiple subsequent sets may further refine this processing, each looking for further more specific tasks, with each node performing some form of processing which need not necessarily operate in the furtherance of that task. The artificial neural network 100 may then predict the location on the face. The prediction may be correct or incorrect.

The feedback system 150 may be configured to determine whether or not the artificial neural network 100 made a correct decision. Feedback may comprise an indication of a correct answer and/or an indication of an incorrect answer and/or a degree of correctness (e.g., a percentage). For example, in the facial recognition example provided above, the feedback system 150 may be configured to determine if the face was correctly identified and, if so, what percentage of the face was correctly identified. The feedback system 150 may already know a correct answer, such that the feedback system may train the artificial neural network 100 by indicating whether it made a correct decision. The feedback system 150 may comprise human input, such as an administrator telling the artificial neural network 100 whether it made a correct decision. The feedback system may provide feedback (e.g., an indication of whether the previous output was correct or incorrect) to the artificial neural network 100 via input nodes 110 a-n or may transmit such information to one or more nodes. The feedback system 150 may additionally or alternatively be coupled to the storage 170 such that output is stored. The feedback system may not have correct answers at all, but instead base feedback on further processing: for example, the feedback system may comprise a system programmed to identify faces, such that the feedback allows the artificial neural network 100 to compare its results to that of a manually programmed system.

The artificial neural network 100 may be dynamically modified to learn and provide better input. Based on, for example, previous input and output and feedback from the feedback system 150, the artificial neural network 100 may modify itself. For example, processing in nodes may change and/or connections may be weighted differently. Following on the example provided previously, the facial prediction may have been incorrect because the photos provided to the algorithm were tinted in a manner which made all faces look red. As such, the node which excluded sections of photos containing large contiguous sections of the color red could be considered unreliable, and the connections to that node may be weighted significantly less. Additionally or alternatively, the node may be reconfigured to process photos differently. The modifications may be predictions and/or guesses by the artificial neural network 100, such that the artificial neural network 100 may vary its nodes and connections to test hypotheses.

The artificial neural network 100 need not have a set number of processing nodes or number of sets of processing nodes, but may increase or decrease its complexity. For example, the artificial neural network 100 may determine that one or more processing nodes are unnecessary or should be repurposed, and either discard or reconfigure the processing nodes on that basis. As another example, the artificial neural network 100 may determine that further processing of all or part of the input is required and add additional processing nodes and/or sets of processing nodes on that basis.

The feedback provided by the feedback system 150 may be mere reinforcement (e.g., providing an indication that output is correct or incorrect, awarding the machine learning algorithm a number of points, or the like) or may be specific (e.g., providing the correct output). For example, the machine learning algorithm 100 may be asked to detect faces in photographs. Based on an output, the feedback system 150 may indicate a score (e.g., 75% accuracy, an indication that the guess was accurate, or the like) or a specific response (e.g., specifically identifying where the face was located).

The artificial neural network 100 may be supported or replaced by other forms of machine learning. For example, one or more of the nodes of artificial neural network 100 may implement a decision tree, associational rule set, logic programming, regression model, cluster analysis mechanisms, Bayesian network, propositional formulae, generative models, and/or other algorithms or forms of decision-making. The artificial neural network 100 may effectuate deep learning.

A large language model may be a language model characterized by its large size. Their size is enabled by AI accelerators, which are able to process vast amounts of text data, mostly scraped from the Internet. The artificial neural networks which are built can contain from tens of millions and up to billions of weights and are (pre-) trained using self-supervised learning and semi-supervised learning. Transformer architecture contributed to faster training.

As language models, they work by taking an input text and repeatedly predicting the next token or word. Up to 2020, fine tuning was the only way a model could be adapted to be able to accomplish specific tasks. Larger sized models, such as GPT-3, however, can be prompt-engineered to achieve similar results. They are thought to acquire embodied knowledge about syntax, semantics and “ontology” inherent in human language corpora large language models are trained using self-supervised learning or semi-supervised learning. This means that they are trained on large amounts of unlabeled text. Large language models can adjust their internal parameters and learn from new inputs from users over time.

Large language models are trained to predict the next word in a sentence based on the previous input sentence. This is a self-supervised learning task because you are not defining separate output labels. The process is repeated until the model reaches an acceptable level of accuracy. Some large language models, like InstructGPT and ChatGPT, use both supervised learning and reinforcement learning. The combination of the two is crucial for optimal performance.

Referring again to FIG. 2, at block 210, a new claim may be analyzed to determine the features determined by a machine learning algorithm in an analysis engine that has analyzed past insurance claims for subrogation amounts and subrogation probabilities. At a high level, a machine learning algorithm may analyze past claims to determine features and to determine a weight for each feature as related to subrogation amounts and subrogation probabilities. The weights may be applied to features in new insurance claims to determine a subrogation probability and subrogation value. For example, a first feature may be weighted more heavily than a second feature as the first feature may have a large impact on determining whether a claim has a high or low subrogation probability. In some embodiments, humans may intervene and adjust the weights as desired. For example, the number of cars in an incident may be a factor with a heavy weight toward determining subrogation probability as a single car incident has a low subrogation probability while a multi-car incident may have a higher subrogation probability.

At block 220 weights determined by a machine learning algorithm in an analysis engine that has analyzed past insurance claims to the features of the new claim may be applied to a new claim. As mentioned, the machine learning algorithm may analyzed features to determine a weight for each feature as related to insurance subrogation. The weights may be applied to features in new insurance claims to determine a subrogation value. For example, a first feature may be weighted more heavily than a second feature as the first feature may have a large impact on determining whether a claim is legitimate or needs to be further reviewed for fraud. In some embodiments, humans may intervene and adjust the weights as desired.

In some embodiments, each claim type is reviewed separately by the machine learning algorithm. Further, the data used in the machine learning algorithm may be specific to each insurance company or the data may be shared among a plurality of insurance companies to better identify subrogation opportunities. And, as mentioned previously, the machine learning models may be continually updated with new data.

At block 230, a subrogation estimate for the new claim may be determined using a value engine. The value engine may analyze a possible subrogation recovery amount and a subrogation success probability from the analysis engine to determine the subrogation estimate. For example, in a multi-car pile-up incident, a first car that caused the initial incident may be responsible for the claims for the additional cars. The claims for the additional cars may be subrogated to the insurance company of the first car. The value of the damage to all the cars may be used as a subrogation amount. The subrogation amount may be useful as there may be situations where the subrogation recovery amount may be small and the logic of pursuing such a small amount may not make sense. In other situations, the subrogation recovery amount may be large and the logic to pursue subrogation may make a lot of sense.

The analysis engine may provide factors and weights to assist in determining the possible subrogation amount. The factors may relate to facts in the underlying claim report. For example, damage estimate to the vehicles in an incident may be given a heavier weight. Somewhat related, facts that are not relevant to subrogation may be given a lower weight. Some sample factors may include whether a person admitted or a report indicated responsibility for a claim, the past success in seeking subrogation with another insurance company, the past success with arguments that are similar to the facts in the current claims, etc. As an example, in a vehicle claim for $20,000 in damage, where each party is 50% responsible may result in an initial subrogation value of $10,000 ($20,000*50%). However, the other insurance company may be notorious for delaying and denying subrogation claims. As a result, the subrogation value may fall by another 25% to $7,500 ($10,000*75%).

At block 240, an offer engine may be used to determine an offer for the claim based on the subrogation value. The offer engine may be able to work in real time and produce an offer value virtually immediately once the subrogation data is received. In one embodiment, an offer engine uses a machine learning algorithm to analyze past offers to determine the offer amount. The offer engine may be specific to each insurance company as each insurance company may have a different approach to subrogating claims. For example, past subrogation examples may be reviewed to determine a proper amount for a subrogation bid. Some sample factors may include the predicted time to receive the subrogation money which may be used to discount the subrogation value to a present value, the past success with similar subrogation facts, the past success with the other insurance companies, etc. The offer may be presented to a claim holding company for acceptance, rejection or counter-offer. The offer may be formatted according to the requirements of an application program interface (API) to ensure efficient and accurate communication of the offer.

In some situations, a plurality of new claims may be aggregated into a claim package. The determined subrogation value for claims in the claim package may be summed and an offer engine may be used to determine an offer for the claim package based on the subrogation value. By creating a claim package, a selling insurance company can quickly obtain a settlement amount and clear out a significant number of subrogation claims at one time. In addition, the package of claims may be more interesting to additional investors as will be explained.

In some embodiments, an auction platform may be used to hold an electronic auction to determine a buyer of a claim or a claim package. In other embodiments, the claim or claim package may be posted to a marketplace for purchase. In some embodiments, buyers may be able to percentages of the claim or claim package.

In yet some further embodiments, the claims may be securitized for sale as securities. Logically, securities may be traded backed by the securitized claim packages with the prices being determined by the market. The securitized trading may result in an even more liquid market for the sale of securitized claims.

The system and method may address and solve many important technical problems in current insurance claim processing. At a high level, at the present time, determining subrogation opportunities may be a very manual operation. The system and method may take vast quantities of data, turn the data into normalized data which may then be analyzed such that computer systems physically configured to analyze the data may produce tangible reports which may then be used to may decisions on the data.

The various engines are physically configured to execute their various tasks in efficient manners. For example, the offer engine may be less processor intensive than the analysis engine as the offer engine is simply searching for an offer value while the analysis engine is more processor intensive as it has more data to analyze. Thus, the two engines may be physically configured differently to more efficiently perform each task. As a result, the tasks may be completed more quickly and use less power and less memory that using devices that are not specifically configure to undertake these tasks.

The system may be provided to insurers or may be available as a service to insurers. For example, the system may be installed physically at an insurance provider or the insurance provider may communicate data to the system which may be remote or in a cloud and the remote system may provide the necessary instructions on how to handle the claims.

### Computing Devices

Computing devices are used through the method and system. Logically, the computing devices may be designed to facilitate the specific tasks that may be part of the method. For example, the large language model may use processors that have superior graphic capabilities to make the large language model operate more efficiently.

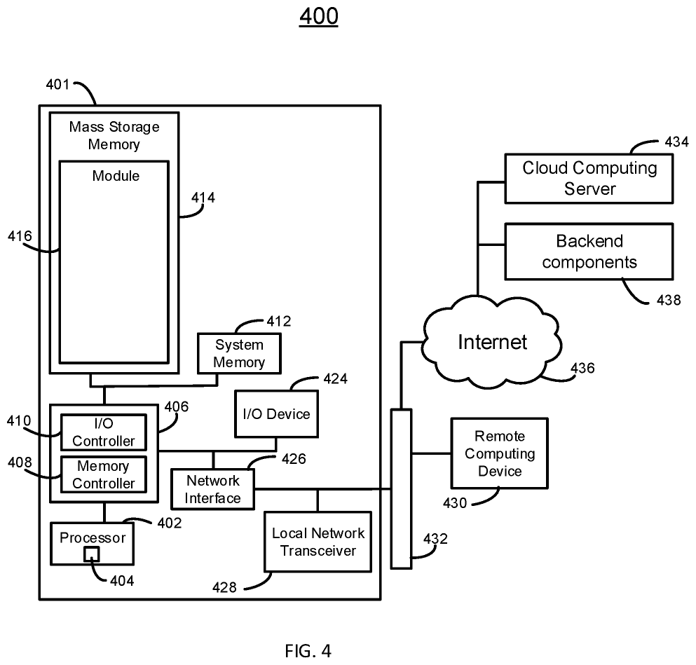

As shown in FIG. 4, the computing device 401 that executes the method may include a processor 402 that is coupled to an interconnection bus. The processor 402 may include a register set or register space 404, which is depicted in FIG. 4 as being entirely on-chip, but which could alternatively be located entirely or partially off-chip and directly coupled to the processor 402 via dedicated electrical connections and/or via the interconnection bus. The processor 402 may be any suitable processor, processing unit or microprocessor. Although not shown in FIG. 4, the computing device 401 may be a multi-processor device and, thus, may include one or more additional processors that are identical or similar to the processor 402 and that are communicatively coupled to the interconnection bus.

The processor 402 of FIG. 4 may be coupled to a chipset 406, which includes a memory controller 408 and a peripheral input/output (I/O) controller 410. As is well known, a chipset may typically provide I/O and memory management functions as well as a plurality of general purpose and/or special purpose registers, timers, etc. that are accessible or used by one or more processors coupled to the chipset 406. The memory controller 408 may perform functions that enable the processor 402 (or processors if there are multiple processors) to access a system memory 412 and a mass storage memory 414, that may include either or both of an in-memory cache (e.g., a cache within the memory 412) or an on-disk cache (e.g., a cache within the mass storage memory 414).

The system memory 412 may include any desired type of volatile and/or non-volatile memory such as, for example, static random access memory (SRAM), dynamic random access memory (DRAM), flash memory, read-only memory (ROM), etc. The mass storage memory 414 may include any desired type of mass storage device. For example, the computing device 401 may be used to implement a module 416 (e.g., the various modules as herein described). The mass storage memory 414 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 401, the systems and methods described herein. Thus, a module, block, function, operation, procedure, routine, step, and method can be implemented in hardware, firmware, and/or software.

In one embodiment, program modules and routines may be stored in mass storage memory 414, loaded into system memory 412, and executed by a processor 402 or may be provided from computer program products that are stored in tangible computer-readable storage mediums (e.g. RAM, hard disk, optical/magnetic media, etc.).

The peripheral I/O controller 410 may perform functions that enable the processor 402 to communicate with a peripheral input/output (I/O) device 424, a network interface 426, a local network transceiver 428, (via the network interface 426) via a peripheral I/O bus. The I/O device 424 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 424 may be used with the module 416, etc., to receive data from the transceiver 428, send the data to the components of the system 100, and perform any operations related to the methods as described herein. The local network transceiver 428 may include support for a Wi-Fi network, Bluetooth, Infrared, cellular, or other wireless data transmission protocols. In other embodiments, one element may simultaneously support each of the various wireless protocols employed by the computing device 401. For example, a software-defined radio may be able to support multiple protocols via downloadable instructions. In operation, the computing device 401 may be able to periodically poll for visible wireless network transmitters (both cellular and local network) on a periodic basis. Such polling may be possible even while normal wireless traffic is being supported on the computing device 401. The network interface 426 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 408 and the I/O controller 410 are depicted in FIG. 4 as separate functional blocks within the chipset 406, the functions performed by these blocks may be integrated within a single integrated circuit or may be implemented using two or more separate integrated circuits. The computing environment 400 may also implement the module 416 on a remote computing device 430. The remote computing device 430 may communicate with the computing device 401 over an Ethernet link 432. In some embodiments, the module 416 may be retrieved by the computing device 401 from a cloud computing server 434 via the Internet 436. When using the cloud computing server 434, the retrieved module 416 may be programmatically linked with the computing device 401. The module 416 may be a collection of various software playgrounds including artificial intelligence software and document creation software or may also be a Java® applet executing within a Java® Virtual Machine (JVM) environment resident in the computing device 401 or the remote computing device 430. The module 416 may also be a “plug-in” adapted to execute in a web-browser located on the computing devices 401 and 430. In some embodiments, the module 416 may communicate with back end components 438 via the Internet 436.

The system 400 may include but is not limited to any combination of a LAN, a MAN, a WAN, a mobile, a wired or wireless network, a private network, or a virtual private network. Moreover, while only one remote computing device 430 is illustrated in FIG. 6 to simplify and clarify the description, it is understood that any number of client computers may be supported and may be in communication within the system 400.

Additionally, certain embodiments may be described herein as including logic or a number of components, modules, blocks, or mechanisms. Modules and method blocks may constitute either software modules (e.g., code or instructions embodied on a machine-readable medium or in a transmission signal, wherein the code is executed by a processor) or hardware modules. A hardware module may be a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” may be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” may refer to a hardware module. Considering embodiments in which hardware modules are temporarily configured (e.g., programmed), each of the hardware modules need not be configured or instantiated at any one instance in time. For example, where the hardware modules include a processor configured using software, the processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification may be presented in terms of algorithms or symbolic representations of operations on data stored as bits or binary digital signals within a machine memory (e.g., a computer memory). These algorithms or symbolic representations may be examples of techniques used by those of ordinary skill in the data processing arts to convey the substance of their work to others skilled in the art. As used herein, an “algorithm” may be a self-consistent sequence of operations or similar processing leading to a desired result. In this context, algorithms and operations may involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, may be merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “embodiments,” “some embodiments” or “an embodiment” or “teaching” may mean that a particular element, feature, structure, or characteristic described in connection with the embodiment is included in at least one embodiment. The appearances of the phrase “in some embodiments” or “teachings” in various places in the specification may not necessarily all be referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments may not be limited in this context.

Further, the figures depict preferred embodiments for purposes of illustration only. One skilled in the art may be readily recognize from the following discussion that alternative embodiments of the structures and methods illustrated herein may be employed without departing from the principles described herein.

Upon reading this disclosure, those of skill in the art may appreciate still additional alternative structural and functional designs for the systems and methods described herein through the disclosed principles herein. Thus, while particular embodiments and applications have been illustrated and described, it is to be understood that the disclosed embodiments may not be limited to the precise construction and components disclosed herein. Various modifications, changes and variations, which may be apparent to those skilled in the art, may be made in the arrangement, operation and details of the systems and methods disclosed herein without departing from the spirit and scope defined in any appended claims.

1. A method of determining a subrogation value of one or more insurance claims comprising:
normalizing the data on the insurance claim using a normalization engine to create normalized data;
analyzing a new claim to determine the features determined by a machine learning algorithm in an analysis engine that has analyzed past insurance claim;
applying weights determined by a machine learning algorithm in the analysis engine that has analyzed past insurance claims to the features of the new claim;
determining a subrogation estimate for the new claim in a value engine; and
using an offer engine to determine an offer for the claim based on the subrogation value.

2. The method of claim 1, further comprising:
aggregating a plurality of new claims into a claim package;
summing the determined subrogation value for the claim package; and
using an offer engine to determine an offer for the claim package based on the subrogation value.

3. The method of claim 1, further comprising presenting the offer to a claim holding company for acceptance, rejection or counter-offer.

4. The method of claim 1, further comprising holding an electronic auction to determine a buyer of the claim package.

5. The method of claim 1, further comprising posting the marketplace for bids.

6. The method of claim 1, further comprising allowing a plurality of buyers to buy percentages of the claim package.

7. The method of claim 1, further comprising securitizing claim packages for sale.

8. The method of claim 1, further comprising trading securities backed by the securitized claim packages.

9. The method of claim 1, further comprising continually updating the machine learning algorithm with new data.

10. The method of claim 1, wherein the claims have types and the types are for at least one of:
home claims;
personal property claims;
vehicle claims;
casualty claims;
liability claims;
health claims;
pet claims;
disability claims;
business interruption claims;
professional liability claims;
flood claims;
commercial claims;
umbrella claims; and
travel insurance claims.

11. The method of claim 10, wherein each claim type is reviewed separately by the machine learning algorithm.

12. The method of claim 1, wherein the model works in real time.

13. The method of claim 1, wherein the offer engine is specific to the claim holding company.

14. The method of claim 1, wherein the value engine analyzes a possible subrogation recovery and a subrogation success probability from the analysis engine to determine the subrogation estimate.

15. The method of claim 1, wherein the offer engine uses a machine learning algorithm to analyze past offers to determine the offer amount.

16. A computer system for determining a subrogation value of one or more insurance claims comprising a processor, a memory and an input-output circuit, the processor being physically configured according to computer executable instruction for:
normalizing the data on the insurance claim using a normalization engine to create normalized data;
analyzing a new claim to determine the features determined by a machine learning algorithm in an analysis engine that has analyzed past insurance claim;
applying weights determined by a machine learning algorithm in the analysis engine that has analyzed past insurance claims to the features of the new claim;
determining a subrogation estimate for the new claim in a value engine; and
using an offer engine to determine an offer for the claim based on the subrogation value.

17. The computer system of claim 16, wherein the processor is further configured according to computer executable instruction for:
aggregating a plurality of new claims into a claim package;
summing the determined subrogation value for the claim package; and
using an offer engine to determine an offer for the claim package based on the subrogation value.

18. The computer system of claim 16, wherein the processor is further configured according to computer executable instruction for allowing a plurality of buyers to buy percentages of the claim package.

19. The computer system of claim 16, wherein the processor is further configured according to computer executable instruction for securitizing claim packages for sale.

20. The computer system of claim 19, wherein the processor is further configured according to computer executable instruction for trading securities backed by the securitized claim packages.
